(19) United States
(12) Patent Application Publication
(10) Pub. No.: US 2004/0014517 A1
(43) Pub. Date: Jan. 22, 2004

(54) Game machine

(75) Inventor: Haruo Inoue, Tokyo (JP)

Correspondence Address: YOUNG & THOMPSON, 745 SOUTH 23RD STREET 2ND FLOOR, ARLINGTON, VA, 22202

(73) Assignee: DRAGON CO., LTD., Tokyo (JP)

(21) Appl. No.: 10/303,725

(22) Filed: Nov. 26, 2002

(30) Foreign Application Priority Data
Jul. 17, 2002 (JP) 2002-208581

(51) Int. Cl. A63F 13/00

(52) U.S. Cl. 463/20

(57) ABSTRACT

A game machine has plural reel rows for performing the slot game independently. Each reel row includes plural reel units arranged side by side. The reel unit is a double-reel, which consists of an inner reel and an outer reel rotating independently with overlapped. The inner reel and the outer reel carry plural symbols. Symbols of the inner reel are observable through the outer reel. Stop position of each outer reel is determined by lottery so that symbol arrangement by the outer reels become common in all reel rows. Each inner reel stops at the independently determined position.

### BACKGROUND OF THE INVENTION

1. Field of the Invention

The present invention relates to a game machine having double-reel structure, particularly to a slot machine.

2. Explanations of the Prior Arts

There are known several types in game machines, for instance a slot machine, such as a mechanical type which rotates plural reels around which symbols are arranged, and a video type which simulates reel display by graphic data stored into ROM. In a slot machine, when a start button or a start lever is operated after inserting coins (medals and tokens are included in the present embodiment), symbols are displayed while rotating. Then, on depressing a stop button provided for every reel to stop the reel, or when the reels are automatically stopped in succession after a random period, whether winning or not, and, in case of winning, what kind of winning is determined by combination of symbols on a winning combination. In case of winning, award coins are paid out. For example, there are some kinds of winning that award coins are paid out in accordance with a rank of the symbol combination, or a chance of bonus game is given.

Since it is difficult for a slot machine of mechanical type to immoderately increase kind and number to be allocated for one reel, a double-reel type which consists of a transparent outer reel and an inner reel rotating inside the outer reel is proposed. As a result, the number of combination can be increased, realizing an increase of a variety of winnings. Conventional slot machines have three reels arranged in a row. Yet, nine reels of three lines and three rows are also known. When one coin is bet, three reels on the first row are effectuated. In case of two coins, three reels on the first and the second rows are effectuated. In case of three coins, three reels on the first to third rows are effectuated. Upon a game start, the three reels on the effectuated rows are rotated simultaneously, and, after a predetermined period, are stopped successively. Whether winning or not is determined by each row. Based on the result, the reels are controlled to stop. If a winning symbol combination is completed, award coins are paid out in accordance with odds of each row. In such a slot machine, a player can obtain three winning chances, which increases expectation for winning.

Moreover, a slot machine with double-up game is also known. The double-up game is an additional game that determines whether to increase award coins dispensed upon winning at a predetermined magnification. It is conducted automatically or optionally by a player when a specific symbol combination occurs. According to the slot machine with double-up game, for example, plural kinds of magnifications are drawn on a rotary disk arranged on an upper part of the slot machine, and if a specific winning hits, the rotary disk is rotated to determine magnification. As it is likely that this slot machine provides a great amount of coins, which is appealing to a player. Moreover, by arranging the rotary disk on the upside of the slot machine, it also appeals to other players the contents of the game.

In the above slot machine on which plural reel rows are arranged, however, judgment of winning permission and stop control of reels based on this is performed by each reel, it is unusual to hit big winning in plural reel rows simultaneously. There are few chances for gaining a large amount of award coins by one game. Due to this, the game was less exciting in spite of its unique structure that plural reel rows are arranged.

### SUMMARY OF THE INVENTION

An object of the present invention is to provide a game machine that offers plural winnings with large amount of award coins at one game so as to be more appealing to a player.

To attain the above object and advantage, a game machine of the present invention is provided with plural reel rows for performing the independent slot game. Each reel row includes plural reel units that are arranged side by side. Of these reel units, one at least is a double-reel, composed of a first reel and a second reel, rotating independently with overlapped. The outer surroundings of the first and second reels carry plural symbols for performing the reel game (slot game). Of the first reel and second reels, symbols of the inner reel are observable through the outer reel. The first reel stop position determining means determines each first reel stop position in the reel row so that symbol arrangement by the first reels is the same in all reel rows. The second reel stop position determining means determines each second reel stop position independently.

The reel stop controlling section stops the rotating first and second reels in each position determined by the first reel stop position determining means, and the second reel stop position determining means.

According to the present invention, it is possible to establish the winning under the same condition on plural reel rows, because the stop position of each outer reel or inner reel is determined so as to make the symbol arrangement being the same in all reel rows. In particular, there is some possibility of simultaneous occurrence of large payout winnings, which excites a player to the slot game.

### BRIEF DESCRIPTION OF THE DRAWINGS

The above and other objects and advantages of the present invention will become apparent from the following detailed description of the preferred embodiments when read in association with the accompanying drawings, which are given by way of illustration only and thus are not limiting the present invention. In the drawings, like reference numerals designate like or corresponding parts throughout the several views, and wherein:

FIG. 1 is a front perspective view of a slot machine of the present invention;

FIG. 2 is a front view of a reel row;

FIG. 3 is a front perspective view of a reel unit;

FIG. 4 is an explanatory view illustrating structure of symbols arranged on an inner reel and an outer reel;

FIG. 5 is an explanatory view illustrating structure of a payout determining device;

FIG. 6 is a block diagram illustrating electrical structure of the slot machine;

FIG. 7 is an explanatory view illustrating structure of a stop symbol lottery section;

FIG. 8 is a flow chart illustrating the flow of game;

FIGS. 9 and 10 are flow charts of a slot game in which two coins are betted;

FIGS. 11, 12, and 13 are flow charts the slot game in which three coins are betted;

FIG. 14 is an explanatory view illustrating winning condition;

FIG. 15 is an explanatory view illustrating lost condition; and

FIG. 16 is an explanatory view illustrating double-up winning condition.

### DETAILED DESCRIPTION OF THE EMBODIMENTS

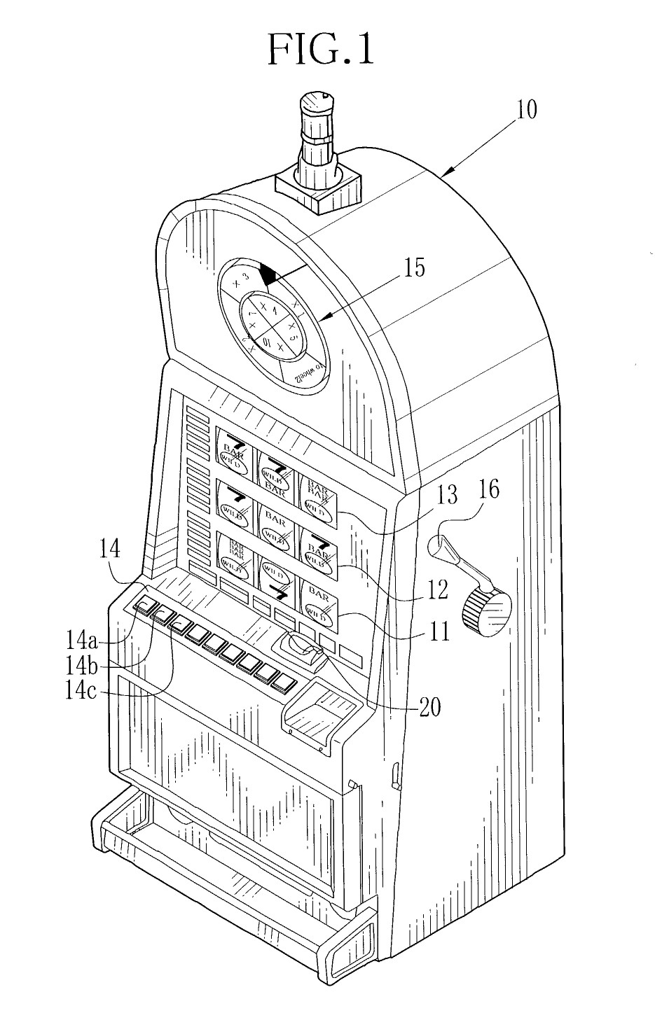

As shown in FIG. 1, the front of a slot machine 10 is provided with a first to third reel rows 11-13, an operation panel 14, a coin saucer, and a payout determining device 15. And there is a start lever 16 on the side of the slot machine 10. The first to third reel rows 11-13 independently perform a reel game (slot game).

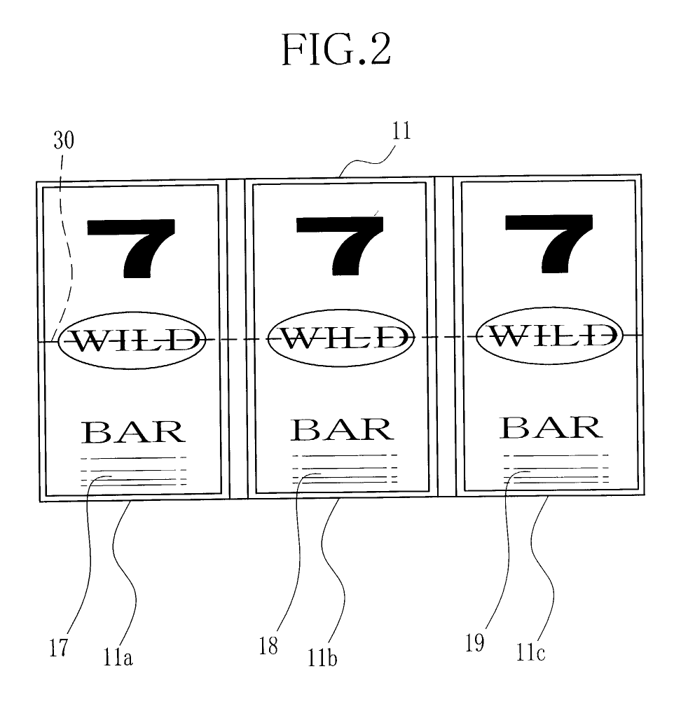

As shown in FIG. 2, the first reel row 11 is taken as an example in the following, as the first to third reel rows 11-13 have the same structure. The first reel row 11 has three symbol display windows 11a-11c, behind which first to third reel units 17-19 are arranged respectively. Symbols are arranged vertically on the first to third reel units 17-19. When the first to third reel units 17-19 stop, three symbols for one reel, namely the total nine symbols, can be observed through the symbol display windows 11a-11c. It is to be noted that the symbol display windows 11a-11c may be formed into a large window.

A winning line 30 shown by a broken line is established so as to cross the three reel units 17-19. Whether winning or lost is determined in accordance with symbol combination arranged on the winning line 30, which is effectuated on betting coins. Coins are inserted into a coin inlet 20, to be betted by a one-coin bet button 14a, a two-coin bet button 14b, or a three-coin bet button 14c arranged on an operation panel 14. On depressing the one-coin bet button 14a, one coin is betted, to start game of the first reel row 11. On depressing the two-coin bet button 14b, two coins are betted, to start game of the first and second reel rows 11 and 12. On depressing the three-coin bet button 14c, three coins are betted, to start game of the first to third reel rows 11-13.

The operation panel 14 is provided with a payout button (not shown) besides the one-coin to three-coin bet buttons 14a-14c. By operating the start lever 16, the first to third reel units 17-19 are rotated. And when a predetermined symbol combination is completed on the winning line 30, the game results in winning.

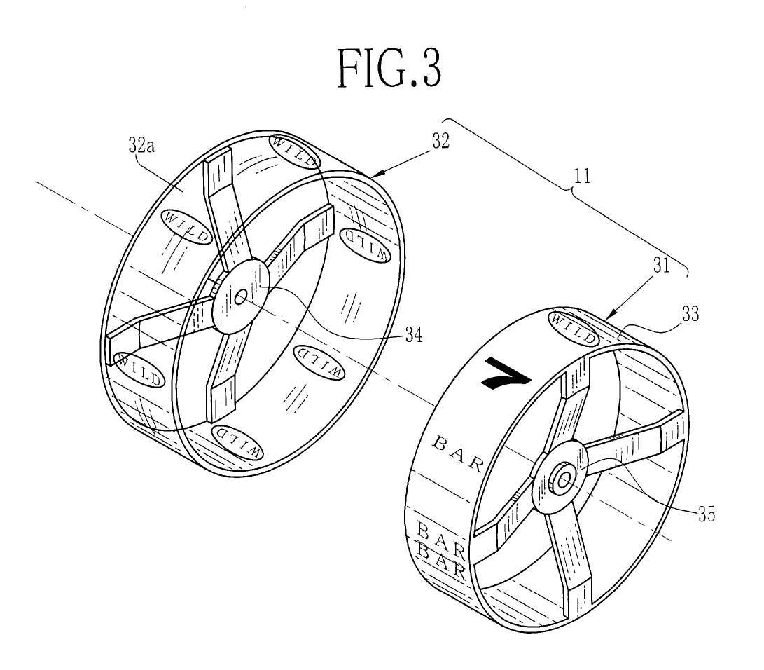

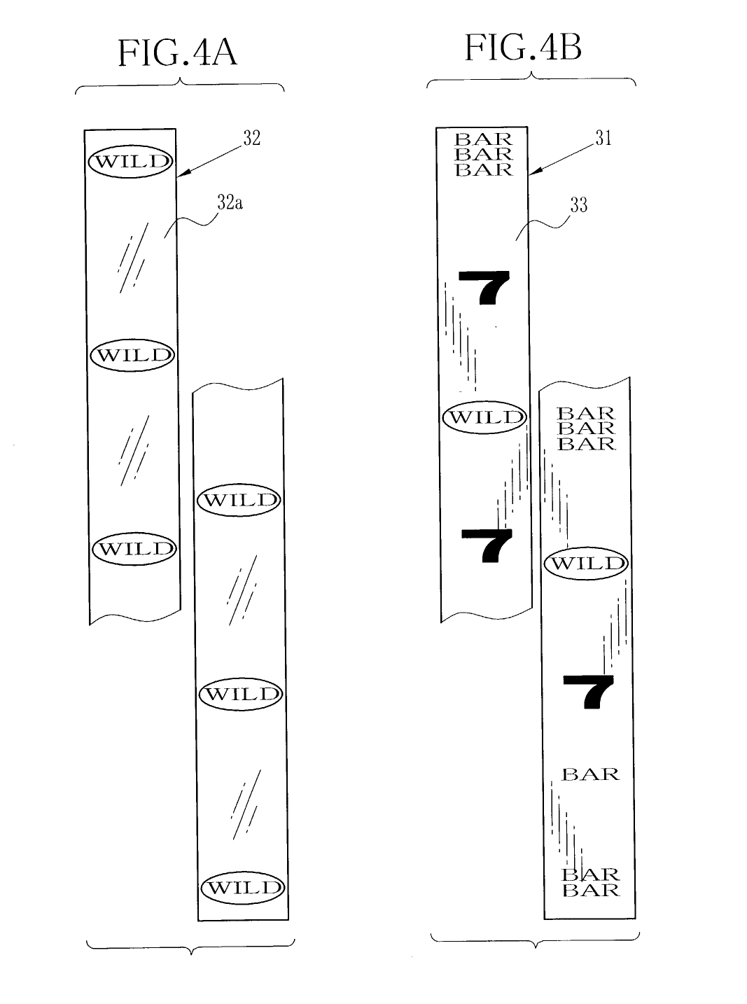

As shown in FIGS. 3 and 4, the first to third reel units 17-19 consist of an inner reel 31 and an outer reel 32 respectively. It is to be noted that the first reel unit 17 is represented to describe its structure, as the first to third reel units 17-19 are of the same structure. In the inner reel 31, it is made from opaque resin material having durable property, and a symbol sheet 33 is put around its outer surface. Five kinds of symbols of “7”, “WILD”, “BAR”, “BAR-BAR”, and “BAR-BAR-BAR” are printed on the symbol sheet 33 of the inner reel 31. Each symbol is arranged on the symbol sheet 33 with a space of one symbol. Note that, the symbol “WILD” functions as an arbitrary symbol. Besides, when the three symbols “WILD” are set on a winning line, a great amount of coins are paid out.

Meanwhile, in the outer reel 32, its outer surface 32a is made from transparent resin. Therefore, the symbols of the inner reel 31 are observable through the outer reel 32. Only the symbol “WILD” is printed on the outer surface 32a of the outer reel 32. Each symbol is arranged on the outer surface 32a with a space of two symbols. The inner reel 31 and the outer reel 32 each have attachment plates 34 and 35 directly connected with stepping motors. The inner reel 31 and the outer reel 32 are rotated by the stepping motors.

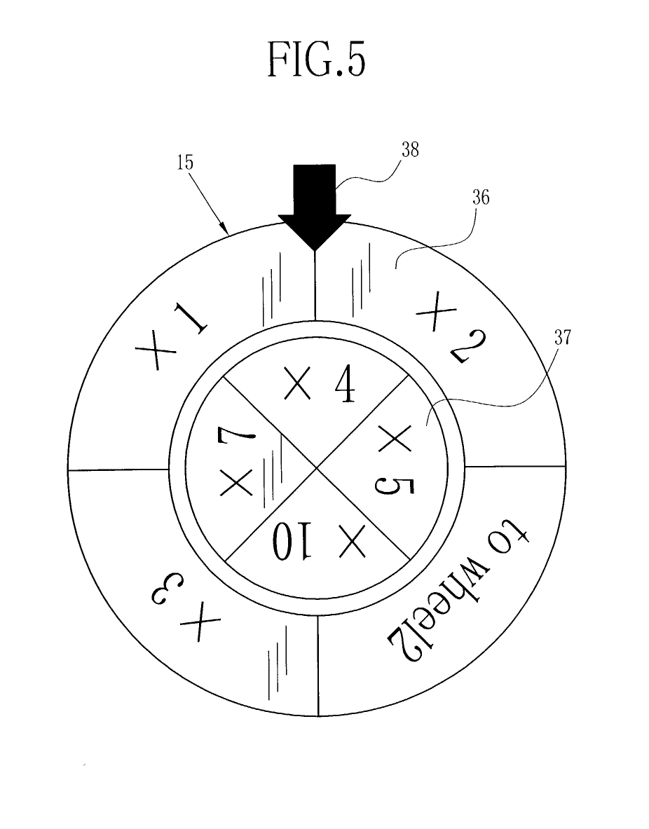

As shown in FIG. 5, the payout determining device 15 is activated when the symbol combination includes the symbol “WILD” upon occurrence of winning in the first to third reel rows 11-13 (it is referred to as double-up winning hereafter). The payout determining device 15 consists of a first rotary disk 36, a second rotary disk 37, and a pointer 38. The first rotary disk 36 starts rotation first upon occurrence of the double-up winning.

The first rotary disk 36 is divided into four spaces, with each having one symbol in each space. The first rotary disk 36 consists of symbols of “x1”, “x2”, “x3”, and “to wheel 2”. The symbol “x1” means that the equivalent numbers of award coin to the double-up winning are paid out. The symbol “x2” means that the twofold award coins are paid out. The symbol “x3” means that the threefold award coins are paid out. And the symbol “to wheel 2” means that the second rotary disk 37 is rotated, which is valid only for the three-coin bet game. When the first rotary disk 36 stops rotation, the award coins corresponding to magnification whose numerical symbol is indicated by the pointer 38 are paid out while playing.

The second rotary disk 37 is divided into four spaces, with each having one symbol in each space. The second rotary disk 37 consists of symbols of “x4”, “x5”, “x7”, and “x10”. The symbol “x4” means that the fourfold award coins to the double-up winning are paid out. Similarly, the symbols “x5”, “x7”, and “10” mean that fivefold, sevenfold, and tenfold coins are paid out respectively.

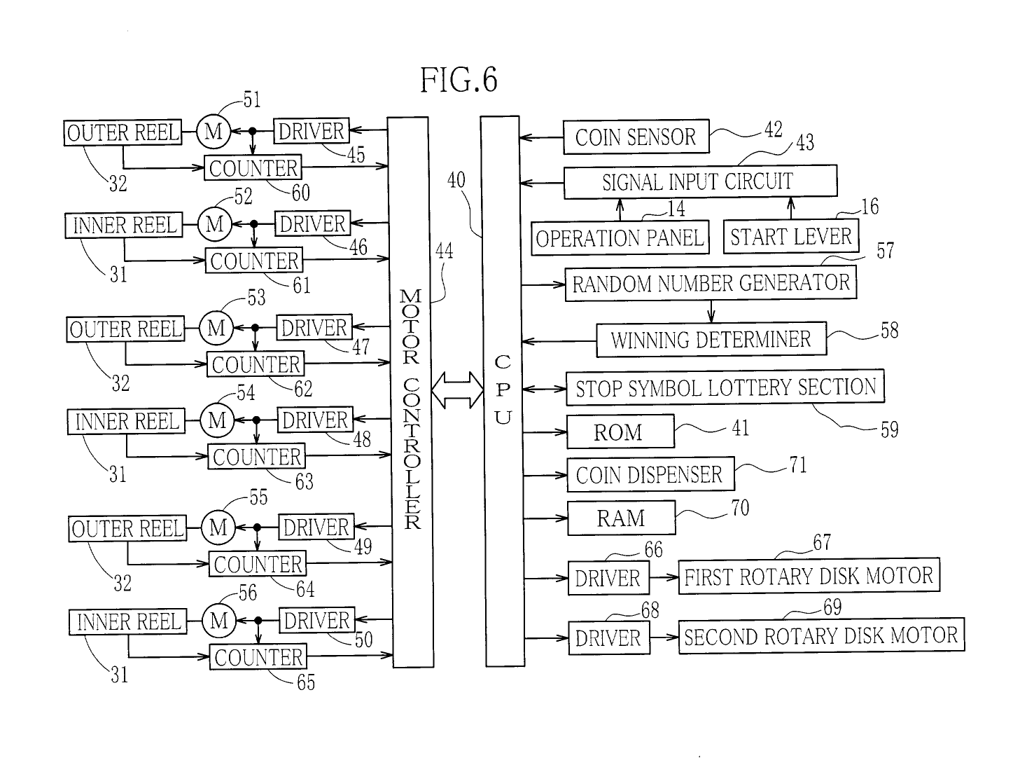

As shown in FIG. 6, the slot machine 10 is activated when a CPU 40 reads out a performing program of the slot game from a ROM 41. A coin sensor 42, disposed behind the coin inlet 20, inputs a coin-detecting signal to the CPU 40 on detecting every insertion of proper coins. On operating the one-coin to three-coin bet buttons 14a-14c on the operation panel 14, an operation signal is inputted from a signal input circuit 43 to the CPU 40. And on operating the start lever 16, a start signal is inputted to the CPU 40, which activates a motor controller 44 in response to the start signal. In accordance with the betted coin number, the CPU 40 effectuates the first to third reel rows 11-13, to make the motor controller 44 control to stop the first to third reel units 17-19. The motor controller 44 supplies drive pulses to the stepping motors 51-56, which are attached to the inner reel 31 and the outer reel 32 of the first to third reel units 17-19 through drivers 45-50, in order to rotate the inner reel 31 and the outer reel 32. The CPU 40 and the motor controller 44 function as reel stop controller.

In synchronism with input of a start signal to the CPU 40, a random number generator 57 samples one random number, which is inputted to a winning determiner 58. The winning determiner 58 determines whether the present game is lost or winning, and, in case of winning, type of winning in accordance with the random number. In case of winning, the winning determiner 58 inputs a winning determining signal to the CPU 40 in correspondence with the type of winning. The CPU 40, in reply to the winning determining signal, activates a stop symbol lottery section 59.

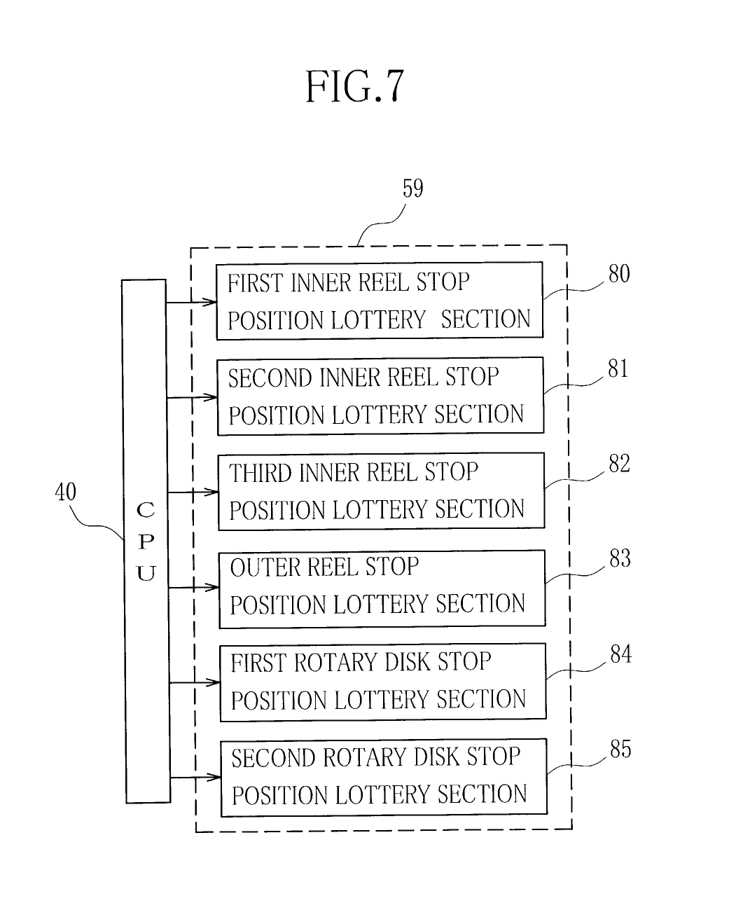

As shown in FIG. 7, the stop symbol lottery section 59 consists of a first inner reel stop position lottery section 80, a second inner reel stop position lottery section 81, a third inner reel stop position lottery section 82, an outer reel stop position lottery section 83, a first rotary disk stop position lottery section 84, and a second rotary disk stop position lottery section 85.

The first inner reel stop position lottery section 80, the second inner reel stop position lottery section 81, and the third inner reel stop position lottery section 82 are activated when operating the first reel row 11, the second reel row 12, and the third reel row 13 respectively. The first to third inner reel stop position lottery sections 80-82 each have the random number generators for generating random numbers in each lottery section, and the inner reel stop position determining tables for dividing all the generated random numbers into groups, where the stop position of each inner reel 31 of the first to third reel units 17-19 are allocated. Due to this, when the first to third inner reel stop position lottery sections 80-82 are activated, the generated random numbers are compared with the inner reel stop position determining tables, so that the stop position of each inner reel 31 is determined by each reel row 11-13. The first to third inner reel stop position lottery sections 80-82 function as the second reel stop position determining means.

The outer reel stop position lottery section 83 has the random number generators for generating random numbers, and the outer reel stop position determining table, where the stop position of each outer reel 32 of the first to third reel units 17-19 are allocated to the group-divided random numbers. Due to this, when plural reel rows are activated, the generated random numbers are compared with the outer reel stop position determining tables, so that the stop positions of the first to third reel units 17-19 are determined the same in spite of reel row types. The outer reel stop position lottery section 83 functions as first reel stop position determining means.

The first rotary disk stop position lottery section 84 is activated when the slot game results in double-up winning.

The first rotary disk stop position lottery section 84 determines stop position of the first rotary disk 36 by lottery. When rotation of the first rotary disk 36 is stopped to be indicated the symbol “to wheel 2” by the pointer 38, the second rotary disk stop position lottery section 85 is activated. The second rotary disk stop position lottery section 85 determines the stop position of the second rotary disk 37 by lottery.

The inner reel 31 and the outer reel 32 have fragments indicating reference position, and their rotation is observed by a photo interrupter. When a reset signal generates from the photo interrupter for every one rotation of the inner reel 31 and the outer reel 32, values counted by counters 60-65, which count the number of drive pulse, are reset to “0”. The counted values by the counters 60-65 indicate rotary position within one reel rotation. It is clear in advance the rotary position of the inner reel 31 and the outer reel 32, and kinds and arrangement of the symbols arranged on the inner reel 31 and the outer reel 32. Therefore, it is possible to distinguish the kind of symbol on the winning line 30 by observing the number of drive pulse supplied to the step motors 51-56.

When the winning determiner 58 gives winning permission, the CPU 40 drives a first rotary disk motor 67 through a driver 66, or a second rotary disk motor 69 through a driver 68 for a predetermined period. Owing to this, the magnification of the award coin numbers is determined. In case the slot game hits winning, the CPU 40 reads out the number of award coin which corresponds to the kind of winning stored in the ROM 41 to store into the RAM 70. On operating the payout button on the operation panel 14, the coin dispenser 71 is driven to dispense the number of coins stored in the RAM 70 to the coin receiver. It is to be noted that the RAM 70 has some areas for storing how many coins are betted and inserted, as well as how many coins are paid out. The RAM 70 is used as temporary storage memory for various data, which is obtained through the process of the game.

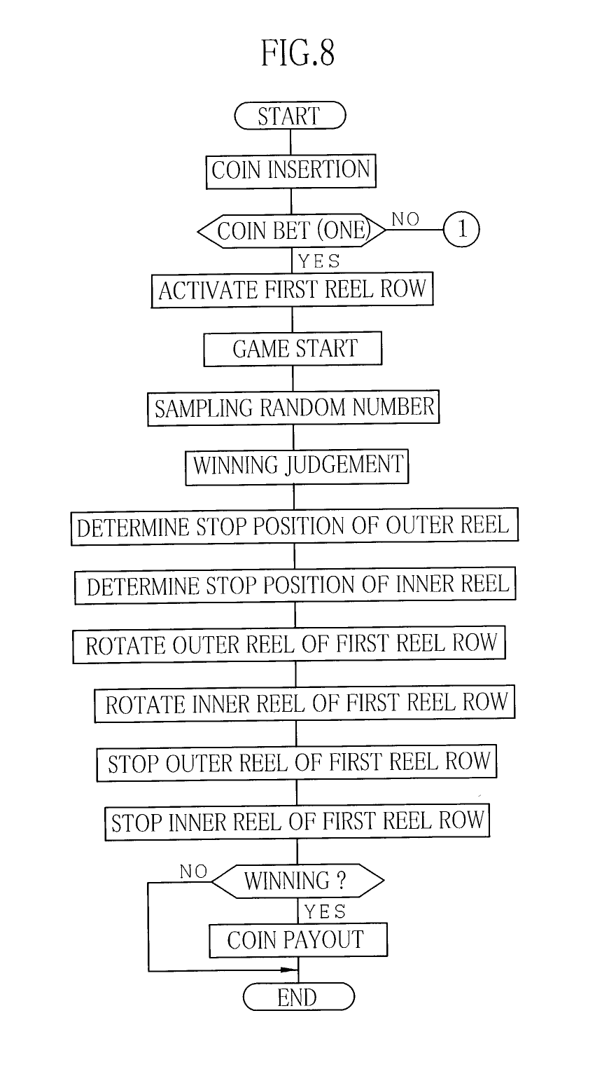

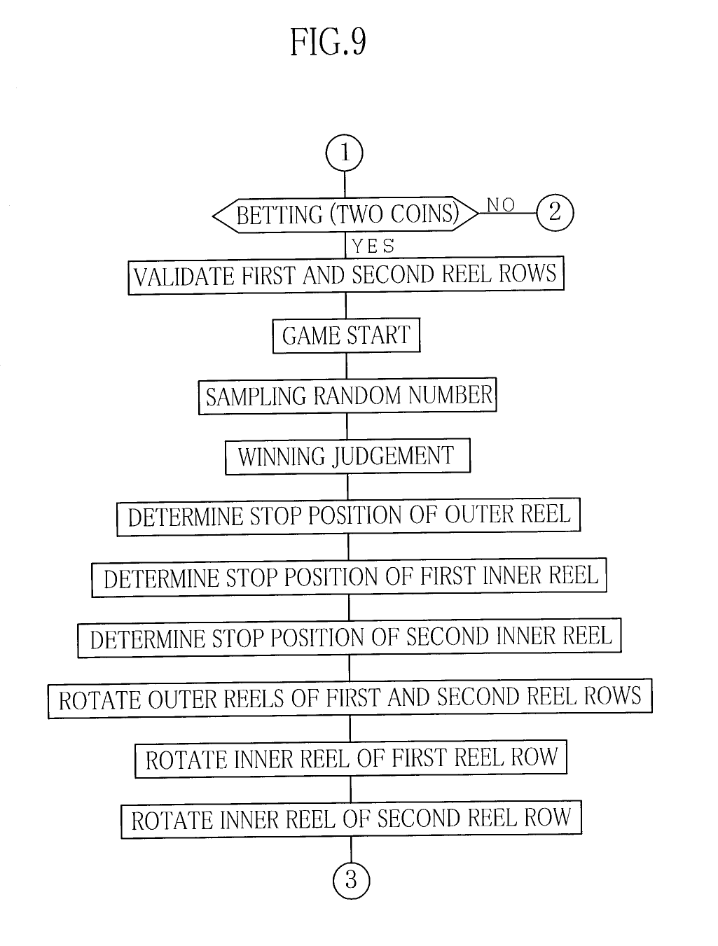

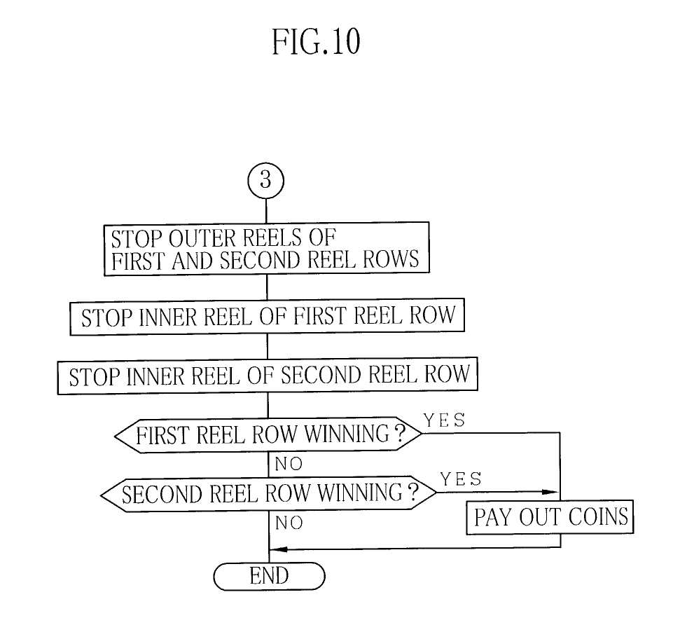

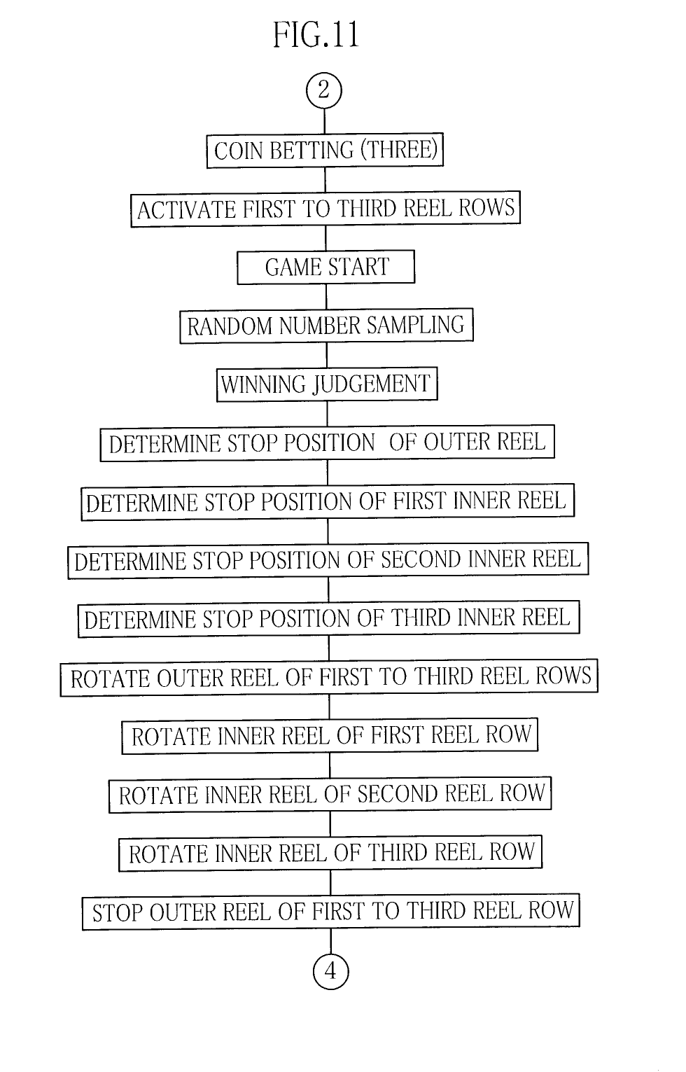

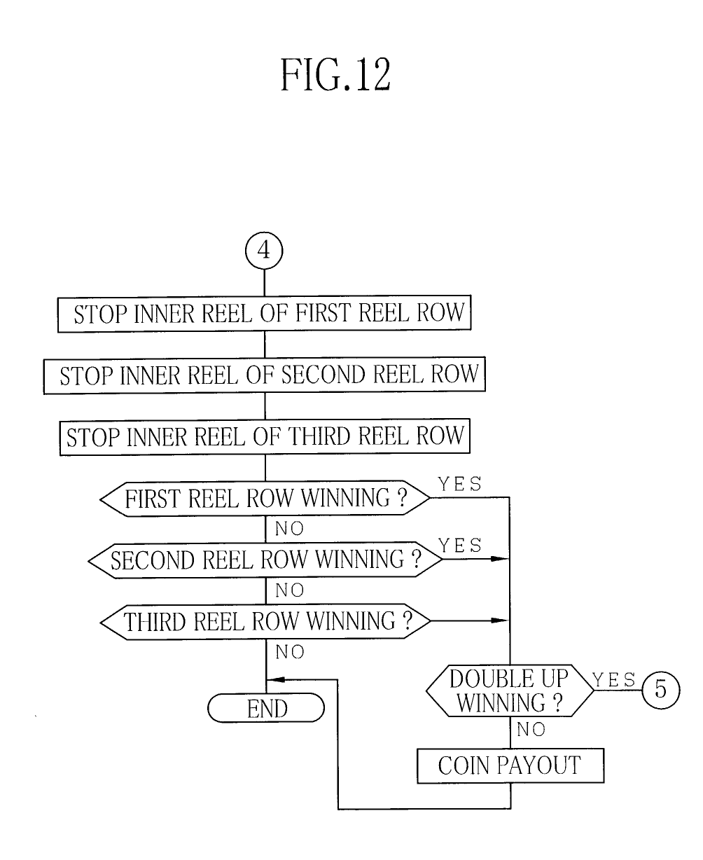

The action of the slot machine 10 is described. As shown in FIGS. 8-12, when a player inserts coins into the coin inlet 20, a coin-detecting signal is inputted from the coin sensor 42 to the CPU 40. After inserting coins, the player depresses the one-coin to three-coin bet buttons 14a-14c on the operation panel 14. An operation signal is inputted from the signal input circuit 43 to the CPU 40, to effectuate the first to third reel lines 11-13 in accordance with the betted coin numbers. When the player depresses the one-bet button 14a, one coin is betted to effectuate the first reel row 11. On operating the start lever 16 for starting a game, a start signal is inputted to the CPU 40. In response to the start signal, the CPU 40 activates the random number generator 57, where random numbers are sampled and inputted to the winning determiner 58. The winning determiner 58 determines whether to effectuate winning or not, and, in case of winning, what kind of winning by lottery.

The CPU 40 activates the outer reel stop position lottery section 83, where reel stop position of the outer reel 32 of the first reel unit 17 is determined by lottery. The CPU 40 also activates the first inner reel stop position lottery section 80, where the stop position of each inner reel 31 is determined by lottery. Subsequently, the CPU 40 activates the motor controller 44, to start rotating each outer reel 32 and the each inner reel 31 of the first reel row 11. After a predetermined period since each inner reel 31 and outer reel 32 start rotation, the CPU 40 commanded the motor controller 44 to stop each outer reel 32 in accordance with the result, determined by the outer reel stop position lottery section 83, and further to stop each inner reel 31 in accordance with the result, determined by the first inner reel stop position lottery section 80.

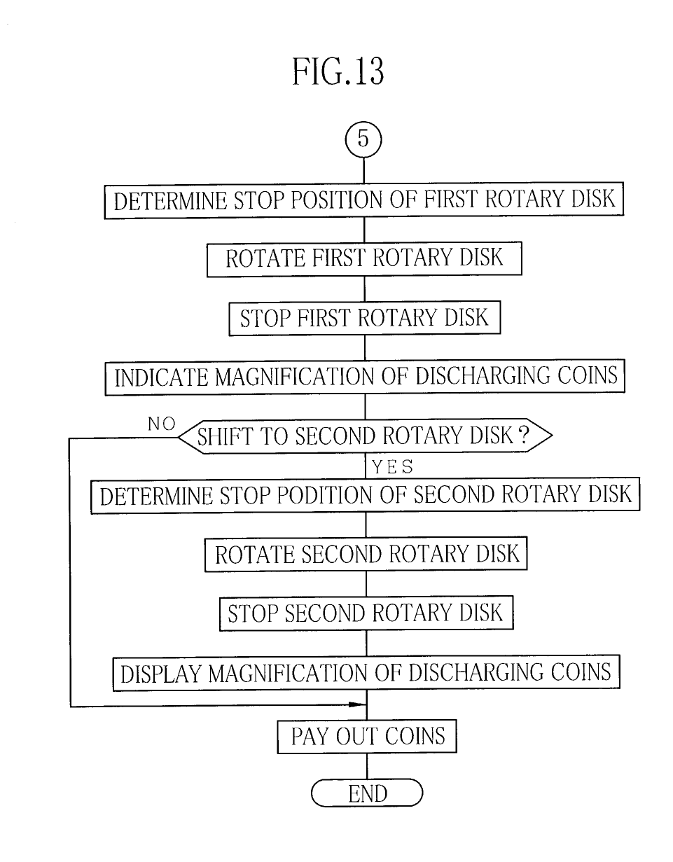

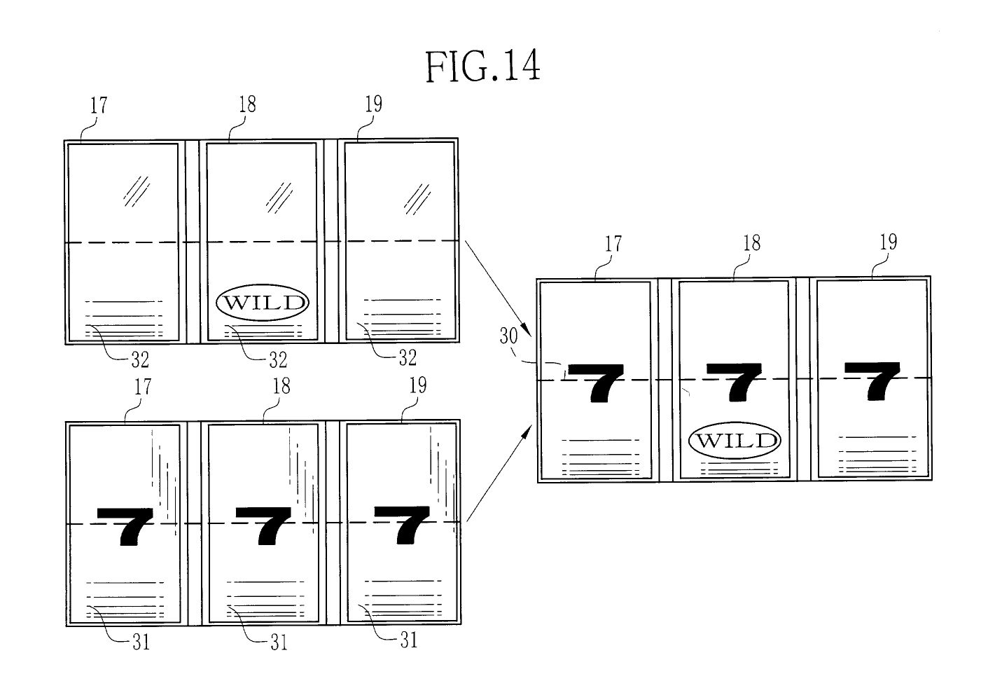

As shown in FIG. 13, in case a predetermined winning symbol combination, such as “BAR-BAR-BAR”, is completed on the winning line 30 of the first reel line 11, the CPU 40 compares the ROM 41 to store the number of award coins accorded its winning type into the RAM 70. After depressing the payout button on the operation panel 14, the coin dispenser 71 is activated to dispense a predetermined number of coins stored into the RAM 70 to the coin saucer. As shown in FIG. 14, in case lost symbol combination is completed on the winning line 30, the slot game by one game is over.

When the two-coin bet button 14b is depressed to bet two coins, the first and second reel rows 11 and 12 are effectuated. The slot game starts, to determine whether the game results in winning or lost. Besides, the outer reel stop position lottery section 83 determines stop position of each outer reel 32 when the same symbol arrangement appears on the first and second reel rows 11 and 12. In other words, the outer reel 32 of the same reel line stops at the same stop position in the first and second reel rows 11 and 12. Needless to say, stop position of each outer reel 32 is separately determined in the reel row. For this reason, it is possible, for example, to complete the three “WILDs” on the winning line of the first reel row 11 and/or second reel row 12 upon a stop of each inner reel 31 when each outer reel 32 stops rotation to arrange the two “WILDs” on the winning line in both of the first and second reel rows. This provides chances to complete the symbol “WILD” on both of the first and second reel rows 11 and 12. A large amount of award coins are paid out in case three “WILDs” are completed on the winning line. Therefore, the possibility for completing this symbol combination in two reel rows can increase player's expectation to the winning.

The first and second inner reel stop lottery sections 80 and 81 separately determine the stop position of each inner reel 31 of the first and second reel rows 11 and 12. Then the CPU 40 activates the motor controller 44 to start the reel to rotate in order of “each outer reel 32 of the first and second reel rows 11 and 12→each inner reel 31 of the first reel row 11→each inner reel 31 of the second reel row 12”. When a predetermined period has passed after reel rotation, the reels are stopped to control in order of “each outer reel 32 of the first and second reel rows 11 and 12→each inner reel 31 of the first reel row 11→each inner reel 31 of the second reel row 12”. In case winning is established at least in either the first reel row 11 or the second reel row 12, coins are paid out.

When three-coin bet button 14c is depressed to bet three coins, the first to third reel rows 11-13 are activated. When the slot game starts, whether winning or not is judged. The outer reel stop position lottery section 83 determines the stop position of each outer reel 32 so as to arrange the same symbol in the same reel line, in spite of determining the stop position one by one in the row. For this reason, for instance, there are some possibilities that the outer reels 32 stop rotation to set two “WILDs” on the winning line and each inner reel 31 stops rotation to set three “WILDs” on at least one of the three winning lines. Besides, there is another possibility for instance that one symbol “7” stops on at least one winning line to complete the arrangement of “WILD”-“7”-“WILD” to obtain the double-up winning. Three chances by the first to third reel rows 11-13 are available, increasing a player's expectation to the winning.

The first to third inner reel stop position lottery sections 80-82 determine stop position of each inner reel 31 of the first to third reel rows 11-13. The CPU 40 activates the motor controller 44 to rotate reels in order of “each outer reel 32 of the first to third reel rows 11-13→each inner reel 31 of the first reel row 11→each inner reel 31 of the second reel row 12→each inner reel 31 of the third reel row 13”. A predetermined period has passed after reel starts rotation, the reels are stopped to control in order of “each outer reel 32 of the first to third reel rows 11-13→each inner reel 31 of the first reel row 11→each inner reel 31 of the second reel row 12→each inner reel 31 of the third reel row 13”. In case winning except for the double-up winning occurs in at least one of the first to third reel rows 11-13, coins are paid out.

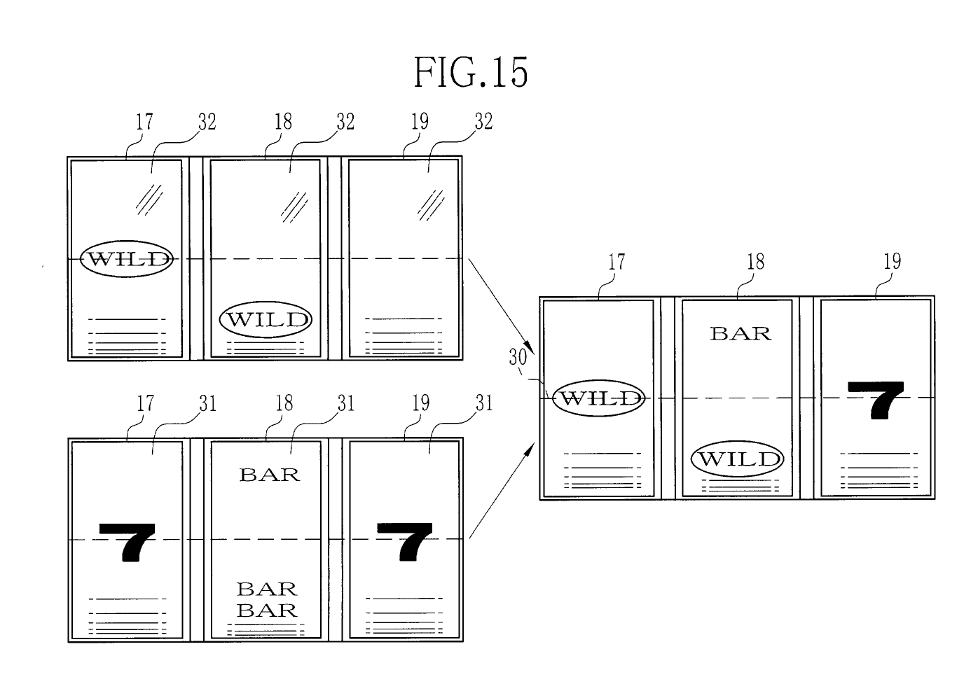

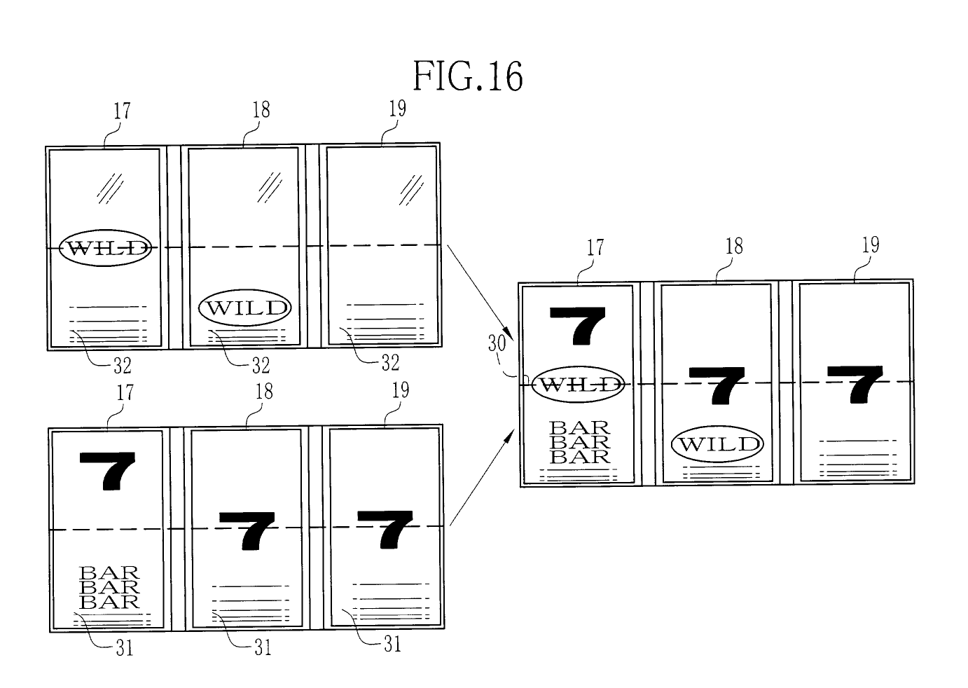

As shown in FIG. 15, symbol combination including the symbol “WILD” is established in at least one of the first to third reel rows 11-13, the double-up winning is completed, to activate the first rotary disk stop position lottery section 84, which determines stop position of the first rotary disk 36 by lottery. The CPU 40 drives the first rotary disk motor 67 through the driver 66 to rotate the first rotary disk 36. After a predetermined period since the first rotary disk 36 starts rotation, the first rotary disk 36 is stopped at the position determined by the first rotary disk stop position lottery section 84.

When the pointer 38 points any of the symbols “x1”, “x2” and “x3” upon rotation stop of the first rotary disk 36, the award coins whose amount is multiplied in accordance with the symbol number pointed by the pointer 38 is given to a player. When the pointer 38 points the symbol “to wheel 2”, the CPU 40 activates the second rotary disk stop position lottery section 85, which determines stop position of the second rotary disk 37 by lottery. The CPU 40 drives the second rotary disk motor 69 through the driver 68 to rotate the second rotary disk 37. After rotating the first rotary disk 36 for a predetermined period, the second rotary disk stop position lottery section 85 determines stop position of the second rotary disk 37.

When the pointer 38 points any of the symbols “x4”, “x5”, “x7”; and “x10” upon rotation stop of the second rotary disk 37, the award coins whose amount is multiplied in accordance with the symbol number pointed by the pointer 38 is given to a player. In the present embodiment, three reel rows are provided. Any numbers are suitable, without limiting to that number.

Although in the present embodiment, the number of symbols observable through the display windows is three, and the number of winning lines for one reel row is one, the number may be suitably determined. Besides that, it is possible to change any contents of the game properly, such as the number of bettable coins, the kinds of winnings, the number of award coins, and the forth. It is more appealing to a player by adding illumination effects and sound performance, if winning occurs or the final reel stops to establish winning.

In the present embodiment, the number of reel unit is three for one row, and all reel units are double-reels by the inner reel 31 and the outer reel 32. However, the double-reel may be one or two for one row. Moreover, it is possible to stop the reel in arbitrary order and manner. Further, in order to stop the inner reel beforehand, it is preferable that the outer reel has a transparent part, which is equivalent to a size of three symbols in the inner reels, for making the rotating symbols of the inner reel be recognizable through this transparent part.

Moreover, according to the above embodiment, each outer reel 32 in the same reel lines stop on the same stop position, while each inner reel 31 stops on the separately determined stop position. Contrary to this, it is also suitable that each inner reel 31 in the same reel line positions, while each outer reel 32 stops on individually determined position. Furthermore in the above embodiment, when one symbol “WILD” appears on the winning line while playing the three-coin bet game, the double-up winning is established, to rotate the first rotary disk 36. However, when the symbol “WILD” appears on the valid winning lines while playing the one-coin or two-coin bet game for instance, the double-up winning may be established. It is possible to determine whether to rotate the first rotary disk 36 or the second rotary disk 37 by lottery, or by condition of winning. And finally, conditions for the double-up winning can be determined in an appropriate manner.

According to the above embodiment, the number of rotary disk of the payout determining device 15 is determined as two, which can be changed to arbitrary numbers. Besides, although the reels make rotation upon operation of the start lever 16 in the above embodiment, the game start button may be provided on the operation panel 14, for example. It is possible to rotate the reels in an appropriate way, for instance, the reels make automatic rotation upon depressing the one-coin to three-coin bet buttons 14a-14c. In addition to the slot machine of mechanical type, the present invention is also applicable to another amusement machines, such as slot machines of video type, game machines, pachinko machines, and the like.

Although the present invention has been fully described by the way of the preferred embodiments thereof with reference to the accompanying drawings, various changes and modifications will be apparent to those having skill in this field. Therefore, unless otherwise these changes and modifications depart from the scope of the present invention, they should be construed as included therein.

What is claimed is:

1. A game machine comprising:
plural reel rows for performing reel game independently, each reel row including plural reel units arranged side by side, at least of said plural reel units being a double-reel, which has a first reel and a second reel being rotated separately with overlapped;
plural symbols carried on outer surroundings of said first and second reels, said symbols of inner one being observable through outer one of said first and second reels;
a first reel stop position determining means for determining stop position of each first reel in said each reel row so that symbol arrangement by said first reels being equal in all said reel rows;
a second reel stop position determining means for determining stop position of each second reel separately; and
a reel stop controlling means for stopping said rotating first and second reels at stop position which is determined by said first reel stop position determining means and said second reel stop position determining means.

2. A game machine as claimed in claim 1, wherein the number of said reel rows for performing said reel game is increased in accordance with betted coin numbers so as to activate said only one reel row when one coin is betted.

3. A game machine as claimed in claim 1 wherein, said first reel is an outer reel, while said second reel is an inner reel, and said inner reel is received into said outer reel.

4. A game machine as claimed in claim 3, wherein said symbol is positioned at a pitch P1 in said outer reel, while said symbol is position at a pitch P2 in said inner reel, said pitch P1 is kept for a space of said two symbols, while said pitch P2 is kept for a space of one symbol.

5. A game machine as claimed in claim 2, further comprising
a first and second rotary disks which rotate independently with overlapped, each rotary disk carrying numerals for representing magnification of award coins.

6. A game machine as claimed in claim 3, wherein said outer reel and said inner reel have a specific symbols respectively, when winning symbol combination including said specific symbol accomplishes, said first or said second rotary disk rotate to determine magnification of award coins for said winning symbol combination.

7. A game machine as claimed in claim 5, wherein said inner reel and said outer reel are driven by stepping motors respectively.
